(19) United States
(12) Patent Application Publication
(10) Pub. No.: US 2013/0189925 A1
(43) Pub. Date: Jul. 25, 2013

(54) Pairing Wireless Device Using Multiple Modalities

(71) Applicants: Liam Staskawicz, San Francisco, CA (US); Jared Hanson, Oakland, CA (US); Jeevan Kalanithi, San Francisco, CA (US); David Merrill, San Francisco, CA (US); Micah Elizabeth Scott, San Francisco, CA (US)

(72) Inventors: Liam Staskawicz, San Francisco, CA (US); Jared Hanson, Oakland, CA (US); Jeevan Kalanithi, San Francisco, CA (US); David Merrill, San Francisco, CA (US); Micah Elizabeth Scott, San Francisco, CA (US)

(73) Assignee: SIFTEO, INC., San Francisco, CA (US)

(21) Appl. No.: 13/560,952

(22) Filed: Jul. 27, 2012

Related U.S. Application Data
(60) Provisional application No. 61/513,561, filed on Jul. 30, 2011.
(60) Provisional application No. 61/513,478, filed on Jul. 29, 2011.

(51) Int. Cl. H04B 7/24

(52) U.S. Cl. CPC H04B 7/24
USPC 455/41.1; 455/41.2

(57) ABSTRACT

The protocols necessary to establish a communication relationship between two wireless devices is established by first boot-strapping a configuration message using a first communication means to establish a temporary communicative state so that the two devices can thereafter explore, authenticate and thereafter establish a formal communication relationship using a second communication means. A transceiver can be used to determine the proximity of one device to another can also be used to establish and convey a configuration message providing the necessary information for the establishment of a communication relationship. Using signals generated by modulated electro-magnetic fields, a configuration message can be sent from one device to another device once the second device comes within a certain proximity of the first. Using this message, the second device can be informed as to the steps necessary to configure a high-bandwidth wireless transceiver for reception of pairing information. Once received, an authentication message containing unique information can be transmitted back to the first device establishing a formal communication relationship. Thus, as presented above, two devices can be wirelessly paired with minimal user interaction and with minimal gap in the perception as to which two devices are targeted.

### RELATED APPLICATION

The present application relates to and claims the benefit of priority to U.S. Provisional Patent Application No. 61/513,561 filed Jul. 30, 2011 and U.S. Provisional Patent Application No. 61/513,478 filed Aug. 1, 2011, both of which are hereby incorporated by reference in its entirety for all purposes as if fully set forth herein.

### BACKGROUND OF THE INVENTION

1. Field of the Invention

Embodiments of the present invention relate, in general, to systems for human-computer interaction and more particularly to establishing a communication relationship among a particular subset of wireless devices.

2. Relevant Background

With the proliferation of network-enabled mobile devices, such as mobile phones, smart phones, wireless speakers, wireless head-sets, etc., pairing separate mobile devices to establish a relationship for communication has become more and more common. This has led to many new applications such as file swapping, music sharing, and collaborative gaming, and other application where nearby users engage in spontaneous wireless data communications through their mobile Bluetooth, WiFi and similar interfaces. A prerequisite for such device-to-device connectivity is device pairing. Such a point-to-point connection must be set up before the two devices can engage in an interaction in which data or instructions are exchanged.

The first challenge in pairing is identifying which device among many is the intended target of the pairing request. Consider the pairing of two phones so as to convey some data; pictures for example, in local coffee shop. At any one time there may be 10 or more devices within range of the two targeted devices that are capable of being paired. So the identification and selection of the desired target is fundamental challenge to wireless pairing. Accordingly, there needs to be a mechanism to enable to user to indicate to the initiating phone which nearby phone among many is the intended target, and, while in this example mobile phones are used at the targeted devices one skilled in the relevant art will appreciate that there are numerous type of devices which could be paired in this manner. This mechanism involves bridging a “perception gap” in device pairing; that is where a user knows clearly what the intended target is, but that knowledge must be translated into a piece of identification information understood at the device level. There are many ways to achieve such an identification. For example, current Bluetooth approaches typically adopt a “scan-and-select” model, where the initiating device scans the wireless channel and lists a set of nearby devices from which to pick a selection. The user then selects which device among those listed to pair to, which is thereafter confirmed by way of inputing a code. Thus, traditionally there is a certain degree of human/user interaction required to initiate and complete the pairing process.

The challenge, therefore, is how a device may effectively identify, capture and interpret and complete a pairing intention with minimal user interaction. That is, among the many nearby wireless devices, how does a system identify the one device that is the user's intended pairing target? It is a non-trivial problem given the differences between how people communicate with each other versus how devices sense our interactions.

It is also desirable to have a device pairing paradigm that negates or minimizes the perception gap. That is, a user needs only to convey a selection target with some form of natural action, and the system can thereafter capture the user intention, automatically identify the right pairing target and initiate the pairing sequence. It remains a challenge to develop an intuitive and effective design that can easily capture the intention of selecting a device while avoiding misinterpretation.

As a point of reference and as understood for purposes of the present invention, if a device X is “paired” to a Host Y, the two devices will be allowed to have a wireless communication link with each other if they are turned on and are in the same vicinity. If devices are not paired, they will not establish communication, even if they happen to be transmitting on the same channel. A typical interaction flow to establish pairing between a mobile phone and a headset is as follows:
Initiate pairing mode on headset using some combination of button-presses
Initiate pairing mode on phone using phone's graphical UI
Phone then scans for all pair-able devices in the vicinity and displays a list
User navigates list on phone, recognizes headset, (typically by make/model) and selects desired headset using phone UI
Headset requests a password, user enters on phone using phone's UI (optional)
Pairing is complete, devices may now communicate wirelessly

The example above further illustrate the challenges inherent in the prior art. That is (1) initiating the pairing mode on the headset can be difficult due to its limited UI, and (2) finding the desired headset by make/model in the list in the phone UI can be difficult if the user does not know this information. And of course this can be made especially difficult if the vicinity is crowded with other devices that appear in the list of available devices as and if the device does not prominently display its make/model on its exterior.

A new type of wireless computer interface comprised of a collection of small interactive devices (Cubes) that users physically manipulate by hand is also confronted with the “pairing” challenge. These cubes can communicate wirelessly among themselves and with another processor or computer (“Host”). Moreover the number of cubes connected to a particular Host is variable, and Cube+Host systems may operate in close proximity with other Cube+Host systems.

The Cubes discussed herein represent a distributed tangible user interface comprising a set of compact manipulable tiles or devices, each tile including a micro-controller, battery, a feedback mechanism (such as a display or auditory generator) accelerometer sensor, onboard memory, button/touch sensor, and sensors for detecting nearby tiles (such as radio, sonic, ultrasonic, visible light, infrared, image-based (camera) capacitive, magnetic, inductive or electromechanical contact sensors).

A system like the Cubes described above features multiple wireless devices with the same make/model. Enabling users to select and pair a particular cube (device) while ignoring others is a challenge. Since devices of this type communicate wirelessly, a cube that the user intends to pair to a host may appear indistinguishable (from the Host's point of view) to other cubes that are across the room. Such a situation can be problematic. For example, if pairing is automatic or “promiscuous” (e.g. not user-initiated), a Host computer will pair to all cubes that are within wireless range and are available for pairing. This can result in cubes being paired to a system other than the system intended by the user. It remains a challenge therefore to efficiently and effectively identify and pair wireless devices requiring minimal user interaction. These and other challenges of the prior art are addressed by one or more embodiments of the present invention.

### SUMMARY OF THE INVENTION

Establishing a communication relationship between two wireless devices can be accomplished, according to one embodiment of the present invention, by utilizing resources and technology present in each of the wireless devices as an alternative communication means. By doing so, the perception gap between devices that are targeted for pairing, and the required user interaction necessary for pairing, can be minimized.

According to one embodiment of the present invention, the protocols necessary to establish a communication relationship between two wireless devices can be established by first boot-strapping a configuration message using close-range technology to establish a temporary communicative state so that the two devices can thereafter explore, authenticate and establish a formal communication relationship on a extended range/high-bandwidth radio. In one embodiment of the present invention, technology used to determine the adjacency and orientation of one device to another can also be used to establish and convey a configuration message providing the necessary information for the establishment of a communication relationship. Using signals generated by the receipt of modulated electromagnetic fields, a configuration message can be sent from one device to another device once the second device comes within a certain proximity of the first. Using this message, the second device can be informed as to the steps necessary to configure a higher-bandwidth wireless transceiver for reception of pairing information. Once this information is exchanged, an authentication message possessing a unique token first conveyed using the configuration message can be transmitted back to the first device verifying the identity of the second device as the recipient of the configuration message to the first device. Thus, as presented above, two devices can be wirelessly paired with minimal user interaction and with minimal gap in the perception as to which two devices are targeted.

The configuration message described above is, in one embodiment, confined to merely initiate communication between the two devices and not to exchange all information necessary to establish a communication relationship. In one embodiment the configuration message is associated with a communication packet that is merely two bytes long, that is sixteen bits. Of the 16 bits, 3 bits of the first byte are fixed leaving 5 free. These five bits normally convey an identification number to uniquely identify the transmitting device. In one version of the present invention these 5 bits identify the packet as a pairing packet by using a reserved identification number. The receiving device, upon seeing the reserved identification code recognizes that this two byte message is a pairing configuration message.

With the two byte packet identified as a pairing packet, the remaining 8 bits can identify information necessary for later communication. For example the first two bits can represent an address index, the next two a channel index with the remaining 4 a checksum validation. Thus the two byte transmission can be identified by the receiving device as a configuration message that merely informs the device on which address and channel to tune its receiver. Thereafter, using a higher bandwidth communication modality, pairing protocols can be exchanged.

Another aspect of the initial communication associated with the configuration message is positional relationship between the first and second devices. As described above, the configuration message is a short message of, in one embodiment, two bytes. However the success of such a short transmission is, in one embodiment, predicated on the positional relationship between the two devices. According to one embodiment the positional relationship determined between the two devices includes factors as range (distance) direction and orientation. This determination is enabled by the establishment of short range communication through, in one embodiment, inductive coupling. Knowing the positional relationship provides confidence that the configuration message is exchanged among the correct devices, thus, reducing the perception gap. While the configuration message is conveyed using a short range, low bandwidth communication means such as inductive coupling, this communication and successful identification of the two devices is based on many factors including geometric shape of the devices, range, and respective orientation of the devices. Without the correct positional relationship, the configuration message, while sent by a first device, would not be received by the second device.

In another embodiment of the present invention, a similar type of configuration message can be conveyed (broadcast) to a plurality of devices within a certain proximity of a central base station or host. Within the configuration message can exist instructions directing the receiving devices to display on a visible display a unique graphic. Thereafter, users can authorize the establishment of a communication relationship with a particular device by either physically interacting with that device or by identifying the same graphic on a list presented by the host, or by doing both actions. In another embodiment, the device initiating the pairing can include visual recognition technology which can identify the particular graphic or fiducial marker shown on the displays of the receiving devices using the video capture capability of the initiating device and displaying the captured scene with recognized regions indicated visually on its graphical display thus creating a mapping from regions in the image on the initiating device to the identities of the other devices, and users can authorize the establishment of a communication relationship with particular devices by selecting them via touching or clicking on them on the screen of the initiating device.

In another embodiment of the present invention, two devices can be paired by showing unique graphical images on the displays of candidate devices at the time of pairing that match graphical images shown in the user interface on the Host. By showing these unique images on both Host and devices and allowing the user to select which devices from the available group they wish to pair by interacting with either the unique on-screen graphical images on the Host or with the devices themselves, or both, this method solves the problem of selecting incorrect wireless devices to pair, especially when many pair-able devices are within wireless range of the Host.

The features and advantages described in this disclosure and in the following detailed description are not all-inclusive. Many additional features and advantages will be apparent to one of ordinary skill in the relevant art in view of the drawings, specification, and claims hereof. Moreover, it should be noted that the language used in the specification has been principally selected for readability and instructional purposes and may not have been selected to delineate or circumscribe the inventive subject matter; reference to the claims is necessary to determine such inventive subject matter.

### BRIEF DESCRIPTION OF THE DRAWINGS

The aforementioned and other features and objects of the present invention and the manner of attaining them will become more apparent, and the invention itself will be best understood, by reference to the following description of one or more embodiments taken in conjunction with the accompanying drawings, wherein:

FIG. 1 shows a high level block diagram of a system for establishing a communication relationship according to one embodiment of the present invention;

FIG. 2 shows a communication flowchart between two devices establishing a communication relationship according to one embodiment of the present invention;

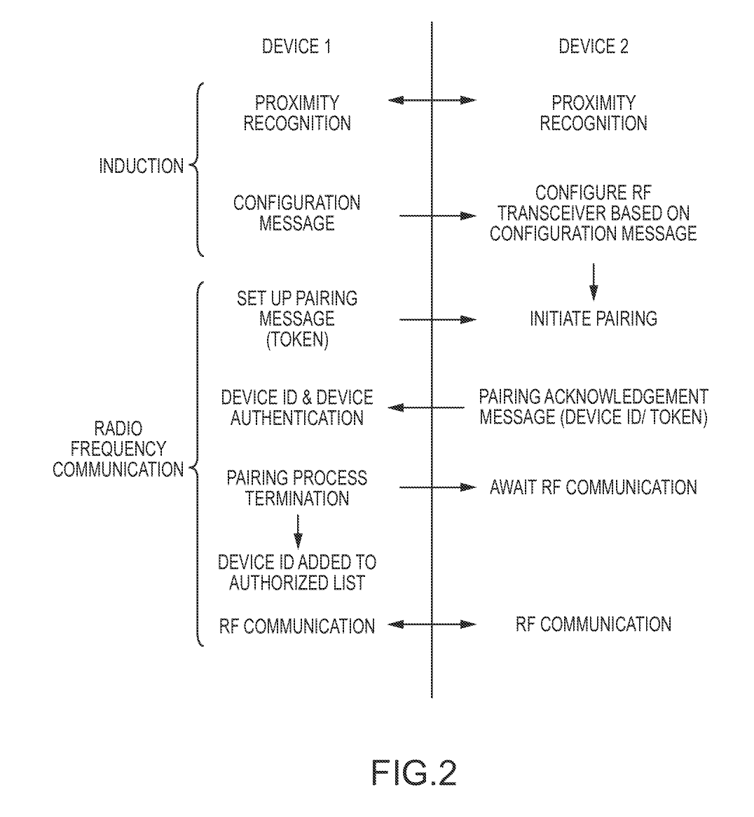

FIG. 3 shows a communication flowchart between two devices establishing a communication relationship according to another embodiment of the present invention;

FIG. 4 is a high level block diagram of a processing environment as may exist for one or more devices establishing a communication relationship according to one or more embodiments of the present invention; and

FIG. 5 shows a one example of a typical data processing system that may be used in one embodiment of the present invention.

The Figures depict embodiments of the present invention for purposes of illustration only. One skilled in the art will readily recognize from the following discussion that alternative embodiments of the structures and methods illustrated herein may be employed without departing from the principles of the invention described herein.

### DESCRIPTION OF THE INVENTION

Presented hereafter by way of example is a system and associated methodology for identifying and pairing wireless devices involving minimal user interaction. While the present invention is applicable to the pairing of any wireless devices, the examples presented below illustrate pairing between devices such as mobile telephones or smart phones, host computers and manipulable devices (also referred to herein as cubes). One skilled in the relevant art will recognize that the following description is equally applicable to any device that possess wireless communication technology.

One implementation of the present invention is with a client/host environment in which a computer or host is paired to one or more wireless user interactive manipulable devices or cubes. The host for such cubes can be any computer capable of running software and capable of communicating wirelessly with the cubes. In one instantiation the host can be a standard (e.g. laptop or desktop) personal computer (PC), while in another instantiation the host can be a base station possessing limited yet task specific processing capability. For example a Sifteo® Base is a special-purpose embedded computer device with processor, memory, storage, radio, speaker, user interface elements, and inductive communication hardware for short-range communication with adjacent Cubes. The Sifteo® Base runs applications that control Sifteo® Cubes wirelessly, and it can sync to a general-purpose computer over USB or wirelessly in order to manage the installed applications and transmit and receive data to and from the Internet.

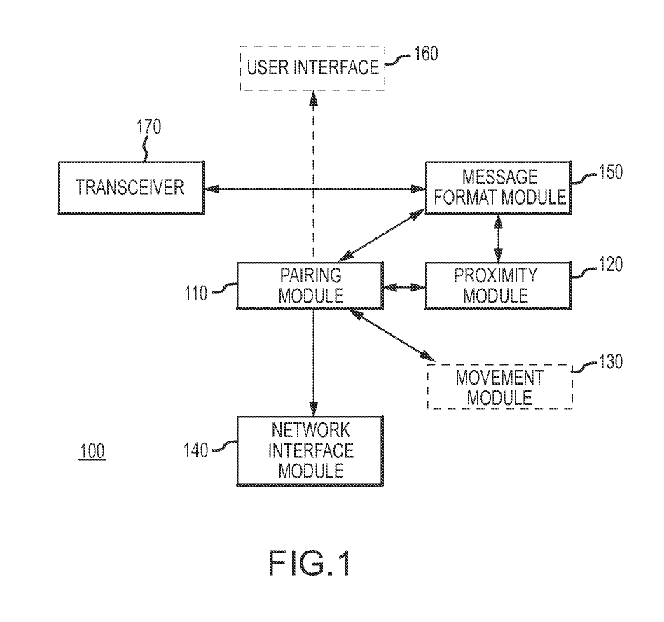

FIG. 1 shows a high level block diagram of a processing system or device that may be used in the establishment of a communication relationship between two devices according to the present invention. This device may be a smartphone, such as an iPhone or similar device, or any consumer electronic device capable of wireless transmission. As previously discussed, the device depicted in FIG. 1 can also include a personal computer or similar laptop or tablet computer, as well as a limited function base station or specific functionality directed device. Moreover, system 100 can also include manipulable user interactive computer interfaces, also known and referred to herein as cubes. As shown in FIG. 1, pairing module 110 is communicatively coupled to a proximity module 120, a movement module 130, a network interface module 140, a message format module 150, optionally, a user interface with 160, and a transceiver 170. As will be appreciated by one of reasonable skill in the relevant art, more or fewer components may exist in other devices that are equally applicable and implementable using one or more embodiments of the present invention.

Whether the system 100 depicted in FIG. 1 is operating as an initiator of communications or as the target, the pairing module 110, in one embodiment of the present invention, interacts with the transceiver, the proximity module 120 and the message format module 150 to ascertain when another device is within a predetermined distance of a device so as to establish a communication relationship. In this reactive embodiment, once triggered by proximity indication, the message format module 150 constructs, for an initiating device, a configuration message which is overlaid/embedded into a short range signal used by the proximity module 120 and transmitted. In a proactive embodiment, the message format module 150 constructs a configuration message which is overlaid/embedded into a short range signal used by the proximity module 120 and transmitted repeatedly without requiring the presence of another device.

The configuration message which is conveyed from initiating device to a receiving device using, in one embodiment of the present invention, a short-range modulated inductive field, enables the targeted device to configure its transceiver 170 so as to listen and receive a setup message. In another embodiment of the present invention, a longer-range configuration message instructs the target device to display various graphics which can then be used to authenticate and initiate a communication relationship via a user interface 160.

The runtime software resident on the host controls games and other applications using the cubes as user interactive devices. The host can utilize inherent wireless communicative capabilities or use a USB dongle having a built-in 2.4 GHz radio. In such a scenario, users interact with the host to start the runtime software, to select (pair) which cubes the software would connect to, and to select, start and stop games. Game audio is played from the host or connected speakers or from headphones plugged into to the host. In addition, the runtime software could access the Internet via the Host's connection or via a connection fro another computer that the Host connects to wirelessly or via USB. Users interact with the host and/or cubes to start the runtime software, to select which cubes the software would connect to, and to select, start and stop games.

Pairing the host and cubes is a prerequisite to the execution of the runtime software and games that follow. One means by which to pair a host to one or more cubes, and according to one embodiment of the present invention, is to first provide the host with a “whitelist” of cube identification numbers with which it has previously paired. By default, the host will connect to, and communicate with only with these previously paired cubes unless a new pairing is initiated. According to another embodiment of the present invention, this list can also provide a list of off-limits cubes to which the host will not initiate, in which case it would be a “blacklist”. In addition, whitelist data associated with a user's account can be stored in an online database (e.g. the cloud). The whitelist can then be downloaded automatically on host login and applied to the runtime software on any host computer or similar device. This allows a user's pairing configuration to follow them to any host, in a manner similar as to how a cube's applications becomes automatically available on any host after they log in and are paired.

While the host establishes communication with previously paired cubes, it is continually transmitting a configuration message using short range communication means by which to discover and initiate a pairing process with new cubes. This configuration message can include a token that uniquely identifies the host to the new cube and/or provides a specific channel and/or addresses on which the cube can communicate with the host using wireless radio. According to one embodiment of the present invention, the short range communication means can be in the form of inductor-based circuits on both the host and/or the cubes that are capable of both generating and receiving patterns of modulated electromagnetic fields. As the devices come within proximity of each other the unique pattern of electromagnetic pulses interacts with the other inductor-based circuits to produce a signal which can be used to carry the configuration message. In other embodiments of the present invention near field communication (NFC) or infra-red (IR) technology or other short-range communication means can be used as a means to convey the configuration message.

Near Field Communication (NFC) is a short-range wireless connectivity technology (also known as ISO 18092) that provides intuitive, simple, and safe communication between electronic devices. Communication occurs when two NFC-compatible devices are brought within four centimeters of one another. NFC operates at 13.56 MHz and transfers data at up to 424 Kbits/second. Because the transmission range is so short, NFC-enabled transactions are inherently secure. NFC standards cover communications protocols and data exchange formats, and are based on existing radio-frequency identification (RFID) standards.

Upon receipt of the configuration message by cube or similar mobile device, the cube configures its radio to a particular pairing configuration and is identified in the configuration message. For example, the configuration message may encode a specific channel and/or address on which to communicate with the host or the configuration message may include specific token which uniquely identifies the host.

Once configured, the cube thereafter listens for a special setup message containing specific information needed to establish a communication relationship. Upon receipt of a set up message from the host, the cube responds with a specific cube identification number and optionally the host token so as to identify itself to the host. Once the host receives confirmation from the cube, the host adds the cube to its list of authenticated and authorized communication devices. The host can thereafter communicate to the cube that the pairing process is complete and initiate normal communication over the radio frequency means. Thereafter, when the cube comes into RF proximity of the host the cube identification number will be matched with those present on the host's list and normal radio frequency communication will be initiated.

Embodiments of the present invention are further described in detail with reference to the accompanying Figures. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

One skilled in the relevant art will recognize that the accompanying drawings are provided to assist in a comprehensive understanding of exemplary embodiments of the present invention, as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces. By the term “substantially,” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Included in the description are flowcharts depicting examples of the methodology which may be used to establish a communication relationship between two or more wireless devices. In the following description, it will be understood that each block of the flowchart illustrations, and combinations of blocks in the flowchart illustrations, can be implemented by computer program instructions. These computer program instructions may be loaded onto a computer or other programmable apparatus to produce a machine such that the instructions that execute on the computer or other programmable apparatus create means for implementing the functions specified in the flowchart block or blocks. These computer program instructions may also be stored in a computer-readable memory that can direct a computer or other programmable apparatus to function in a particular manner such that the instructions stored in the computer-readable memory produce an article of manufacture including instruction means that implement the function specified in the flowchart block or blocks. The computer program instructions may also be loaded onto a computer or other programmable apparatus to cause a series of operational steps to be performed in the computer or on the other programmable apparatus to produce a computer implemented process such that the instructions that execute on the computer or other programmable apparatus provide steps for implementing the functions specified in the flowchart block or blocks.

Accordingly, blocks of the flowchart illustrations support combinations of means for performing the specified functions and combinations of steps for performing the specified functions. It will also be understood that each block of the flowchart illustrations, and combinations of blocks in the flowchart illustrations, can be implemented by special purpose hardware-based computer systems that perform the specified functions or steps, or combinations of special purpose hardware and computer instructions.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Also, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

To further decease the perception gap and increase pairing confidence, that is, that the devices to which a communication relationship is being established corresponds to the devices intended to be paired by the user, an iterative configuration process is initiated. Rather than using a single configuration message followed by a exchange of pairing information on a more robust RF channel, a series of configuration messages are sent using multiple address/channel configurations. To do so, the first device broadcasts a configuration message providing a RF address and channel on which the second device can respond. Any device that is within the proximity of the transmitting device responds on the designated channel. Shortly thereafter the same initiating first device sends another configuration message, however, this configuration message identifies a different address/channel combination. Again the second device(s), gaining new information responds on the designated channel. The more repeated responses by the second device to the changing configuration message, the more likely that the responding device is the desired pairing target. A predetermined threshold can be set to require a pairing targets to remain within proximity of each other for a certain period of time before pairing is initiated. Consider the following example.

Assume that to pair two devices, the devices must be within range and capable of receiving short-range communications for 1 second. One skilled in the relevant art will recognize that the time and number of iterations in this example are arbitrary and are not intended to constrain the scope of the invention. Further assume that the first device transmits a configuration message (either continually broadcasting the message or transmitting the message upon recognition of the proximity of another device) using short-range communication that periodically changes; in this case assume that identified address and channel contained within the message changes every half second. When a second device first receives and recognizes the configuration message it will tune its transceiver to the designated address/channel and contact the first device.

In this embodiment, the first device merely logs the reception as a successful contact. Shortly thereafter a new configuration message is sent from the first device with an altered address/channel combination. The second device, still within range of the short-range communication means, responds on this newly designated channel. Again the first device receives the message and enters the data in the log. When the predetermined number of consecutive successful communications occur (equal in this case to a quantity of successful answers which, in this example may span an amount of time greater than 1 second) the first device responds to the second device to create a communication relationship.

The repeated responsive modification of the second device transceiver increases the likelihood that the correct device has been identified for pairing. Other devices that were transitorily close that received and responded to a configuration message would fail to establish a consistent log of responses and thus be eliminated from consideration. Thus only a device or devices which remain within close proximity for a predetermined period of time are paired.

According to another embodiment of the present invention two wireless mobile devices can be paired by utilizing a graphical interface on at least one of the devices. As the two devices are in proximity of each other, a configuration message sent by one device to the other can direct the other device to display a particular and unique image on the user interface. The image that is displayed on the second device can be instructive as to user interaction to confirm pairing with the first device, for example a graphical image such as “touch or click to pair” along with some identifying image or name of the first device. A user interpreting the graphic can interact with the second device to confirm their selection of the desired device to pair to the first device or host. For example, if a plurality of cubes simultaneously comes within the proximity of a host and none of the cubes has been previously paired with the host, the host using a configuration message can direct each cube to display a unique image on its user interface. The user interpreting the image can then select which cubes she desires to pair by interacting with the desired cubes with the host confirming the establishment of a communication relationship. Similarly, a cube that has been previously paired with the host can be “unpaired” using a similar interaction.

A similar user interactive process can occur using the interface on the first device. As the unique images are displayed by each device, a corresponding representation of the image can be displayed on a graphical display associated with the first device. Rather than interacting with the second device the user can select which device or devices depicted on the display of the first device with which the user desires to establish a communication relationship. Once selected the first device can send a message to the second device changing the graphic providing immediate feedback to the user that pairing in complete.

In another embodiment of the present invention, when pairing mode is entered, a list of currently available-to-pair cubes is displayed on the host, and the system automatically connects in a temporary manner to a certain number of available cubes. Each list entry shows a representation of a single cube. In one embodiment of the present invention, the representation of the cube in this list is a generic graphical image of a cube as well as a unique ID drawn from the Cube's hardware. Physically pressing the screen of any connected cube in the list causes the visual representation of that cube in the interface to immediately change in a way that is noticeable to the user. This interactive feature allows the user to understand which list item in the software user interface corresponds to each physical cube, so that they may select the appropriate cubes from the list user interface for pairing. This synchronized feedback links user action on a physical cube to visual change in the host user interface representation of that particular cube.

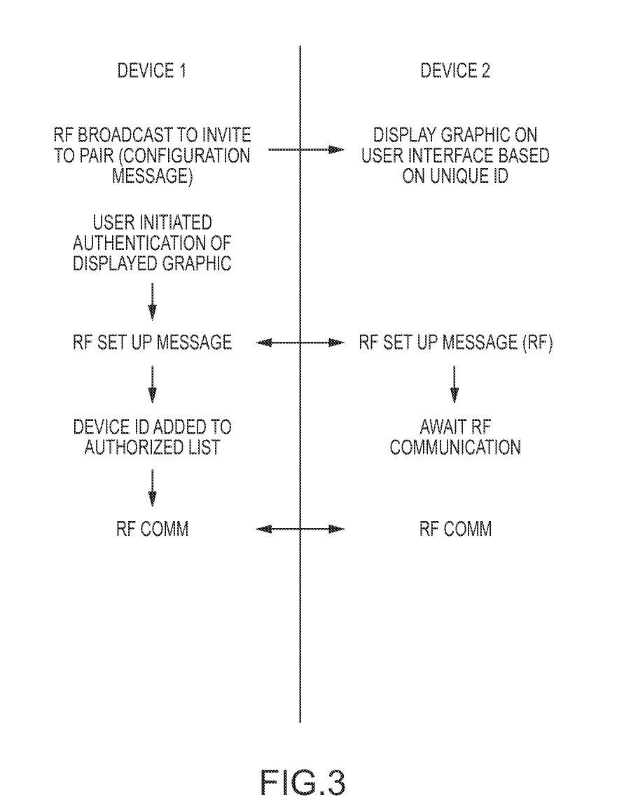

As previously introduced and as depicted in FIG. 3, NFC can be also used as a means to establish a communication relationship between two devices. The pairing process is initiated by placing the NFC sensor of one device near another NFC capable device. In one embodiment, and as described earlier, the first device scans and detects available cubes within its proximity and temporarily establishes a communication link to them. Using a configuration message sent via NFC both devices display a unique image. For example, a user can bring two devices into close proximity with each other so as to initiate near field communication. In other embodiments a configuration message can be broadcast on NFC or other suitable communication frequencies to invite pairing to an receptive device. In such a scenario the configuration message can direct the display on both devices graphical user interface a unique image and query the user to confirm establishment of a communication relationship. As an illustration, a user bringing a cell phone in close proximity with a cube can cause a message to be displayed on cell phone asking whether the user wants to pair with a cube and show an image of, for example, a star. At the same time, and using near field and other suitable types of communications, the cube can be instructed to display a star. Thus, the user is provided with immediate feedback of which device is targeted authenticating the establishment of a communication relationship. Upon confirming the desire to establish a communication relationship with the cube displaying the star using the interface on either device, the image displayed on the cell phone and the cube can be changed to provide the user immediate feedback that the communication relationship has been established.

A communication relationship can also be established through user feedback on both devices. According to one embodiment, a RF signal is transmitted by one device directing nearby devices to each display a different unique graphic. The same set of images is reproduced on the first device. Using a user interface on the first device a user selects one or more devices with which a communication relationship is to be formed. Thereafter the user interacts with the selected targeted devices confirming selection. In one embodiment the user touches a user interface on the device displaying the graphic matching the one presented on the first device. The process could be reversed as well. The user could first interact with the targeted devices and then confirm the pairing by touching the same graphic on the user interface of the initiating device. In both versions the dual interaction by the user confirms the device selection.

In another embodiment of the present invention, optical marker-based detection and augmented reality can be used to allow the user to easily pair two wireless communication devices. Many mobile devices now contain cameras and processors that are operable to recognize optical/fiduciary markers in real-time and to compose dynamic graphics into a live video feed from their camera. According to one embodiment of the present invention graphics, can be inserted into a scene being captured by a camera in real-time as a means by which to establish a communication relationship. At a high-level, this embodiment of the present invention enables the user to utilize the capabilities of a smart phone or similar device to graphically capture an image of a wireless communication device and to select that device using the captured image and the interface of the phone or similar device to establish a communication relationship.

In this embodiment, the user views the other devices “through” the mobile device—that is, the screen of the mobile device (initiating device) displays a live video feed from its camera as the user points the camera at wireless devices they would like to pair. Using a configuration message as previously described herein, the first device causes the proximate devices to show fiduciary markers on their displays. Each un-paired device within range of the first device shows a unique marker. These markers may be transmitted to the devices by the initiating device as fully-rendered graphics or as graphics control commands, or may be generated by software running on the other device based on information sent in the configuration message.

The fiducial markers displayed on the “target” devices are recognized in real-time by software running on the initiating device, and are replaced visually in the live video feed with a “target”—a graphic that invites the user to touch. When a user touches one of these targets, the system pairs with the device represented by the touched target, adding the given target's ID to the whitelist. In another embodiment in which already-paired wireless devices are shown with targets along with not-paired wireless devices, when the user touches the same target a second time or touches the target representing an already-paired wireless device, the system un-pairs the wireless device represented, removing the it from the whitelist. In another embodiment, the graphics displayed on the wireless devices and interpreted by the initiating device need not be visible to the user. Using the capabilities of the displays, camera and the device's processing capability a visual communication so as to establish a radio frequency communication relationship can be conducted in a manner that is not visible by humans. In addition, the identification and pairing of the device can also occur without the use of an explicitly fiducial image such as a 2D barcode but merely by recognition of whatever graphic is being displayed on each device as distinct from the graphics being displayed on other devices.

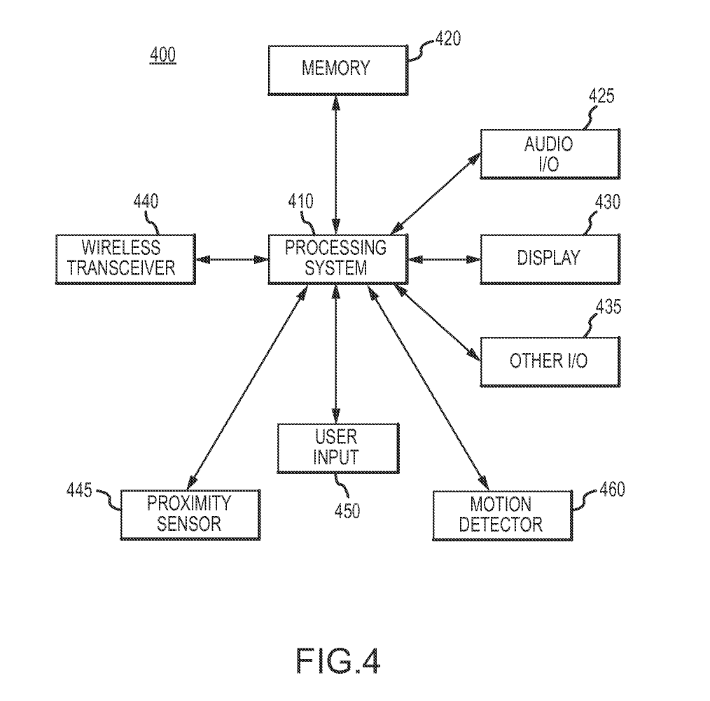

FIG. 4 is a high level representation of a data processing system that may be used with one embodiment of the present invention. For example, system 400 may be implemented as part of the system shown in FIG. 1. The data processing system 400 includes a processing system 410, which may be one or more microprocessors, or which may be a system on a chip integrated circuit, and the system also includes memory 420 for storing data and programs for execution by the processing system. The system 400 also includes an audio input/output subsystem 425 which may include a microphone and a speaker for, for example, playing back music or providing feedback through the speaker and microphone.

A display controller and display device 430 provide a visual user interface for the user; this digital interface may include a graphical user interface which is similar to that shown on an iPhone® phone device or a Sifteo® Cube. The system 400 also includes one or more wireless transceivers 440 to communicate with another data processing system and a proximity sensor 445 by which to identify its proximity and orientation with respect to other devices. The wireless transceiver may be a WiFi transceiver, a generic 2.4 GHz transceiver, an infrared transceiver, a Bluetooth transceiver, a wireless cellular telephony transceiver and/or the like. It will be appreciated that additional components, not shown, may also be part of the system 400 in certain embodiments, and in certain embodiments fewer components than shown in FIG. 4 may also be used in a data processing system.

The data processing system 400 also includes one or more input devices 435 which are provided to allow a user to provide input to the system. These input devices may be a keypad or a keyboard, button, a touch panel or a multi touch panel. The data processing system 400 also includes an optional input/output device 450 which may facilitate a hardwired computer-to-computer connection. In addition the system 400 may optionally include systems operable to detect and measure motion 460 such a accelerometers. It will also be appreciated that one or more buses, not shown, may be used to interconnect the various components, as is well known in the art. The data processing system shown in FIG. 4 may be a handheld computer, or a manipulable user interface, or a personal digital assistant (PDA), or a cellular telephone with PDA like functionality, or a handheld computer which includes a communication capability, or a media player, such as an iPod, or devices which combine aspects or functions of these devices, such as a media player combined with a PDA and a cellular telephone in one device. In other embodiments, the data processing system 400 may be a personal computer or an embedded processing device within another device, or other types of data processing systems such as a base station which have fewer components or perhaps more components than that shown in FIG. 4.

At least certain embodiments of the inventions may be part of a digital media, player, such as a portable music and/or video media player, which may include a media processing system to present the media, a storage device to store the media and may further include a radio frequency transceiver coupled with an antenna system and the media processing system. In certain embodiments, media stored on a remote storage device may be transmitted all or in part to the media player through the RF transceiver from a host or base station. The media may be, for example, one or more of music or other audio, still pictures, motion pictures or other graphical images.

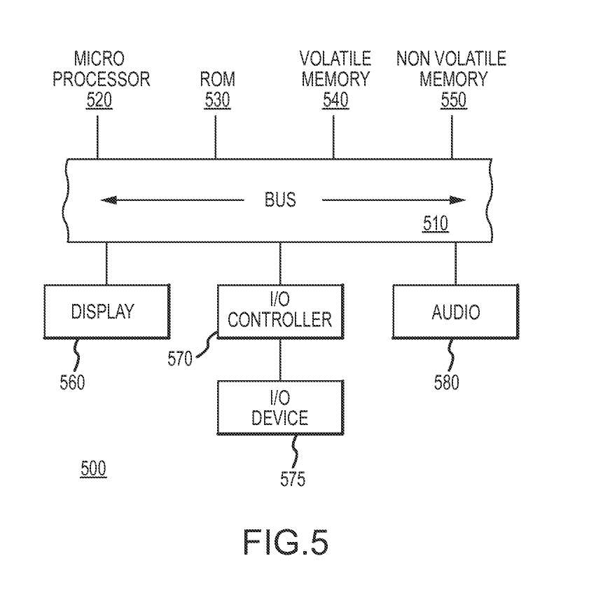

FIG. 5 shows one example of a data processing system such as a computer system, which may be used with one embodiment of the present invention. For example, the system 500 may be implemented as a part of the systems shown in FIG. 1. Note that while FIG. 1 illustrates various components of a computer system, it is not intended to represent any particular architecture or manner of interconnecting the components as such details are not germane to the present invention. It will also be appreciated that network computers and other data processing systems which have fewer components or perhaps more components may also be used with the present invention.

As shown in FIG. 5, the computer system 500 which is a form of a data processing system, includes a bus 510 that is coupled to a microprocessor(s) 520, a ROM (Read Only Memory) 530, volatile RAM 540 and a non-volatile memory 550. The microprocessor 520 may retrieve the instructions from the memories 530, 540, 550 and execute the instructions to perform operations described above. The bus 510 interconnects these various components together and also interconnects these components 520, 530, 540, and 550 to a display controller and display device 560 and to peripheral devices such as input/output (I/O) devices which may be mice, keyboards, modems, network interfaces, printers and other devices, which are well known in the art. Typically, the input/output devices 575 are coupled to the system through input/output controllers 570. The volatile RAM (Random Access Memory) 530 is typically implemented as dynamic RAM (DRAM), which requires power continually in order to refresh or maintain the data in the memory.

The mass storage 550 is typically a magnetic hard drive or a magnetic optical drive or an optical drive or a DVD RAM or a flash memory or other types of memory systems which maintain data (e.g. large amounts of data), even after power is removed from the system. Typically, the mass storage 550 will also be a random access memory, although this is not required. While FIG. 5 shows that the mass storage is a local device coupled directly to the rest of the components in the data processing system, it will be appreciated that the present invention may utilize a non-volatile memory which is remote from the system, such as a network storage device which is coupled to the data processing system through a network interface such as a modem or Ethernet interface or wireless networking interface. The bus 510 may include one or more buses connected to each other through various bridges, controllers and/or adapters, as is well known in the art.

Portions of what was described above may be implemented with logic circuitry such as a dedicated logic circuit or with a micro-controller or other form of processing core that executes program code instructions. Thus, processes taught by the discussion above may be performed with program code, such as machine-executable instructions that cause a machine that executes these instructions to perform certain functions.

In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

As will be understood by those familiar with the art, the invention may be embodied in other specific forms without departing from the spirit or essential characteristics thereof. Likewise, the particular naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the invention, which is set forth in the following claims.

While there have been described above the principles of the present invention in conjunction with system and associated methodology for establishing a communication relationship between two wireless devices, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features that are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The Applicant hereby reserves the right to formulate new claims to such features and/or combinations of such features during the prosecution of the present application or of any further application derived therefrom.

1. A method for establishing a communication relationship between two devices, the method comprising:
determining a positional relationship between a first device and a second device wherein the positional relationship includes range, direction and orientation;
communicating by the first device to the second device, using a first communication means, a configuration message, wherein the first communication means enables determination of the positional relationship between the first device and the second device;
configuring by a second device a second communication means for pairing communications based on the configuration message;
establishing the second means of communication between the first device and the second device; and
adding, by the first device, the second device to a list of authorized devices.

2. The method for establishing a communication relationship between two devices according to claim 1, wherein a proximity between the first device and the second device is detected using inductive coupling.

3. The method for establishing a communication relationship between two devices according to claim 2, wherein communicating the configuration message by the first device is responsive to detecting the second device.

4. The method for establishing a communication relationship between two devices according to claim 1, wherein the first communication means is inductive coupling.

5. The method for establishing a communication relationship between two devices according to claim 1, wherein the first communication means is near field communication.

6. The method for establishing a communication relationship between two devices according to claim 1, wherein the first communication means is infra-red based.

7. The method for establishing a communication relationship between two devices according to claim 1, wherein the configuration message identifies a communication channel unique to the first device on which to initiate pairing communications.

8. The method for establishing a communication relationship between two devices according to claim 1, wherein the configuration message includes a token unique to the first device.

9. The method for establishing a communication relationship between two devices according to claim 8, wherein the second device passes the token back to the first device.

10. The method for establishing a communication relationship between two devices according to claim 1, wherein the configuration message directs the second device to display on the second device an image also displayed on the first device and wherein user interaction with the first device and/or the second device confirms the communication relationship.

11. The method for establishing a communication relationship between two devices according to claim 1, wherein the configuration message directs the second device to display on the second device an image and wherein the first device captures and displays on the first device a video of the image displayed on the second device and responsive to user interaction on the first device designating the video of the image establishing the second means of communication wherein the configuration message directs the second device to display on the second device an image and wherein the first device captures a scene and recognizes the displayed image and displays on the first device a video of the scene that includes the image displayed on the second device and responsive to user interaction on the first device designating the image displayed on the second device, establishing the second means of communication.

12. The method for establishing a communication relationship between two devices according to claim 1, wherein the second communication means is a radio-frequency transceiver.

13. The method for establishing a communication relationship between two devices according to claim 1, wherein the second means of communication is a channel on which the first device periodically transmits a setup message.

14. The method for establishing a communication relationship between two devices according to claim 1, wherein an acceptance message from the second device includes a second device identification code.

15. The method for establishing a communication relationship between two devices according to claim 1, wherein the first device is a base station.

16. The method for establishing a communication relationship between two devices according to claim 1, wherein the first device is a mobile cellular device.

17. The method for establishing a communication relationship between two devices according to claim 1, wherein the second device is a manipulable interactive computer interface.

18. The method for establishing a communication relationship between two devices according to claim 1, wherein the first communication means possesses an effective range substantially less than that of the second communication means.

19. A system for establishing a communication relationship, comprising:
a first device wherein the first device includes a first proximity transceiver and a first wireless communication transceiver;
a second device wherein the second device includes a second proximity transceiver and a second wireless communication transceiver;
a configuration message sent by the first proximity transceiver of the first device and received by the second proximity transceiver of the second device;
a setup message sent by the first wireless communication transceiver of the first device and received by the second wireless communication transceiver of the second device based on the configuration message; and
an acceptance message sent by the second wireless communication transceiver of the second device and received by the first wireless communication transceiver of the first device confirming establishment of a communication relationship.

20. The system for establishing a communication relationship according to claim 19 wherein the first proximity transceiver and the second proximity transceiver are inductors.

21. The system for establishing a communication relationship according to claim 19 wherein the configuration message identifies a communication channel unique to the first device on which to initiate pairing communications.

22. The system for establishing a communication relationship according to claim 19 wherein the configuration message includes a token unique to the first device.

23. The system for establishing a communication relationship according to claim 22 wherein the second device passes the token back to the first device.

24. The system for establishing a communication relationship according to claim 19 wherein the configuration message is sent responsive to proximity between the first device and the second device being detected by communication between the first proximity transceiver and the second proximity transceiver.

25. The system for establishing a communication relationship according to claim 19 wherein the setup message is periodically transmitted by the first wireless communication transceiver of the first device.

26. A system for establishing a communication relationship, comprising:
a first device having a first proximity transceiver;
a second device having a second proximity transceiver wherein bilateral interaction between the first proximity transceiver and the second proximity transceiver determines proximity of the first device to the second device;
an encoder operable to send a configuration message from the first device to the second device using the first proximity transceiver;
a first wireless communication transceiver associated with the first device operable to send a setup message; and
a second wireless communication transceiver associated with the second device operable to receive the setup message based on information within the configuration message and wherein responsive to acceptance of the setup message by the second device the communication relationship is established.

27. The system for establishing a communication relationship according to claim 25, wherein the configuration message identifies a communication channel unique to the first device on which to initiate subsequent communications.

28. The system for establishing a communication relationship according to claim 25, wherein the configuration message includes a token unique to the first device.

29. The system for establishing a communication relationship according to claim 28, wherein acceptance includes passing the token back to the first device.

30. The system for establishing a communication relationship according to claim 25, wherein acceptance includes sending a reply to the setup message.
